(19) United States
(12) Patent Application Publication
(10) Pub. No.: US 2005/0100392 A1
(43) Pub. Date: May 12, 2005

(54) Lip color container

(76) Inventor: Chih-Wen Chen, Mingsyong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,578

(22) Filed: Nov. 12, 2003

(51) Int. Cl. B43K 5/12; B43K 7/06; A46B 11/00

(52) U.S. Cl. 401/192; 401/47; 401/123

(57) ABSTRACT

A lip color container includes an outer shell, and a transparent container part; the outer shell has a holding space, and several gaps thereon; the gaps are made to form patterns; the transparent container part is fitted in the holding space of the outer shell to be protected and strengthened by the outer shell; a cap is detachably fitted around an upper end of the transparent container part; thus, lip colors, the transparent part, and the gaps together increase attractiveness of the whole container, and one can see lip colors contained in the container even if the container is still covered with the cap.

### BACKGROUND OF THE INVENTION

1. Field of the Invention

The present invention relates to a lip color container, more particularly one, which includes a transparent container part protected with an outer shell having gaps thereon such that the user can find out what color a lip color held in the container part is even if the container part is covered with a cap, and such that the lip colors, the transparent part, and the gaps together increase attractiveness of the whole container.

2. Brief Description of the Prior Art

Lip colors are very common cosmetic. Lip colors are usually contained in elongated tube-shaped containers or flat boxes. A conventional elongated lip color container includes a holding part, and a cover for covering the holding part with; to use lip colors, the user has to first open the cover, rub a brush against lip colors in the holding part, and then apply lip colors on her lips with the brush. Another conventional elongated lip color container includes both a cylindrical holding part equipped with a lower knob, and a cap for covering the holding part with; a stick-shaped lip color is held in the holding part and connected with the lower knob such that the lip color can be made to project outwards from the top of the holding part by means of turning the lower knob.

All of the above lip color containers are provided with covers so that dust, moisture etc can't get into the holding part to spoil the lip colors when the lip containers are not in use. Therefore, lip color containers usually have labels or tags attached thereto to tell the user what colors the lip colors are, and a user has to look at the labels or tags to find out what colors the lip colors inside the containers are when the containers are sealed with covers. However, such labels and tags are prone to get lost or damaged because of use. Consequently, one might have to open the covers of all of her lip color containers before she can find the very color she now wants to use. And, it will be waste of time each time one wants to find a desired lip color in case she has many different color lip colors.

### SUMMARY OF THE INVENTION

It is a main object of the present invention to provide a lip color container to overcome the above disadvantages.

The lip color container of the present invention includes an outer shell, and a transparent container part. The outer shell has a holding space, and several gaps, which are made to form patterns. The transparent container part is fitted in the holding space of the outer shell to be strengthened by the outer shell. Thus, lip colors in the transparent part, the transparent part, and the gaps together increase attractiveness of the whole container, and one can see lip colors contained in the container even if the container is still covered with a cap.

### BRIEF DESCRIPTION OF THE DRAWINGS

This invention will be better understood by referring to the accompanying drawings, wherein:

FIG. 1 is an exploded perspective view of the lip color container according to the present invention,

FIG. 2 is a perspective view of the lip color container according to the present invention,

FIG. 3 is a vertical section of the lip color container according to the present invention, and

FIG. 4 is a side view of the lip color container according to the present invention.

### DETAILED DESCRIPTION OF THE PREFERRED EMBODIMENTS

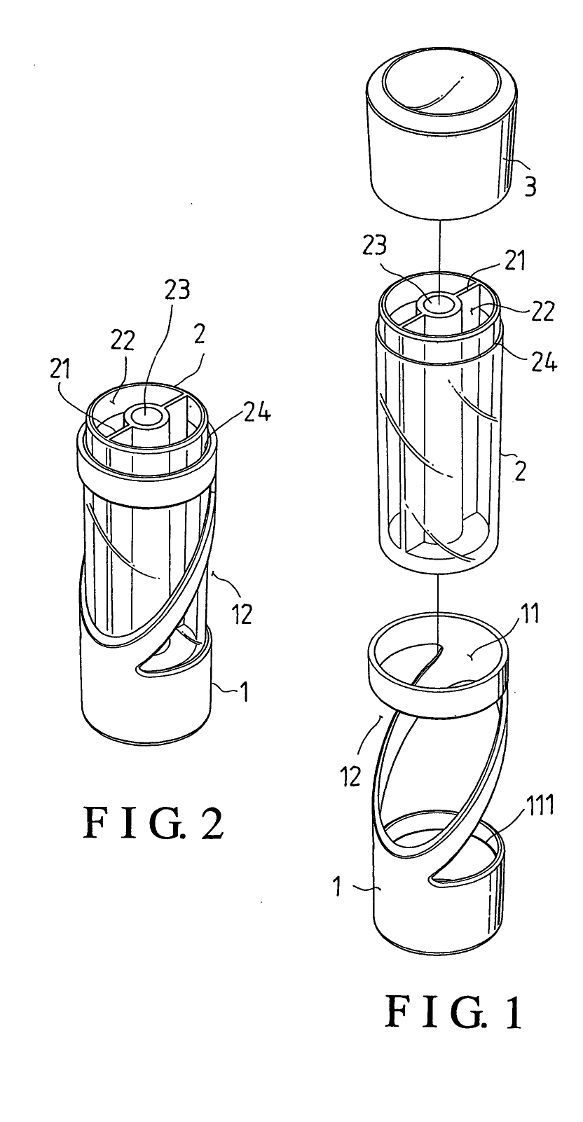

Referring to FIGS. 1, and 2, a preferred embodiment of a lip color container in the present invention includes an outer shell 1, a transparent container part 2, and a cap 3.

The outer shell 1 has a holding space 11, a bottom portion 111 under the holding space 11, and gaps 12 thereon.

The transparent container part 2 has an inner tube portion, which defines an insertion hole 23 in the middle, and several separating plates 21, which are connected with an annular wall of the container part 2 as well as the inner tube portion for dividing an inner space of the container part 2 into several holding rooms 22. The transparent container part 2 further has a step-shaped portion 24 on an outer side of an upper end thereof. The transparent container part 2 is inserted in the holding space 11 of the outer shell 1, and is supported on, and firmly secured to the bottom portion 111 at a lower side thereof by means of ultrasonic wave or other methods.

Different lips colors are respectively contained in the holding rooms 22 of the transparent container part 2 therefore one can easily see the lip colors through the gaps 12 of the outer shell 1 and the transparent container part 2. And, a brush (not shown) can be inserted in the insertion hole 23 of the container part 2.

The cap 3 is detachably fitted around the step-shaped portion 24 of the transparent container part 2 for preventing dust, moisture etc from getting into the container and protecting lip colors held in the container when the lip colors are not in use.

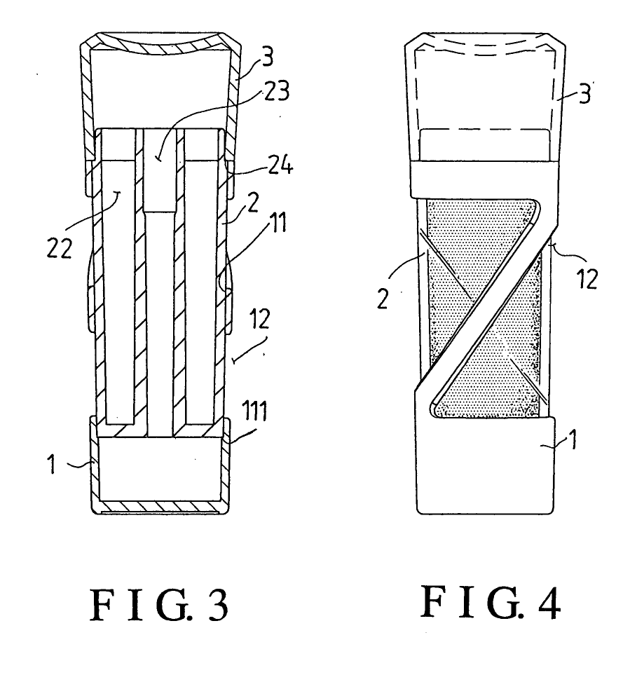

Referring to FIGS. 3 and 4, a user can see lip colors contained in the present container through the gaps 12 of the outer shell 1 and the transparent container part 2, and in turns, she can easily find out what colors the lip colors are in the container even if the container is still covered with the cap 3 while there is no tag or label attached to the container. In addition, the outer shell 1 can protect, and strengthen the transparent container part 2. And, the gaps 12 of the outer shell 1 can be made to form various ornamental patterns such that the transparent container part 2, different lip colors held in the part 2, and the gaps 12 together will increase attractiveness of the whole container. Because there is the insertion hole 23 in the container part 2, the user can put a brush in the hole 23 for her to take and use easily when she wants to apply the lip colors on her lips.

From the above description, it can be easily understood that the lip color container of the present invention is very convenient to use, and more attractive than the conventional ones as described in the Background.

1. An improvement on a lip color container, comprising:
an outer shell having a holding space, and a bottom portion under the holding space;
a transparent container part fitted in the holding space of the outer shell and supported on the bottom portion of the outer shell for containing lip colors therein; the transparent container part having a step-shaped portion on an outer side of an upper end thereof; and
a cap detachably fitted around the step-shaped portion of the transparent container part;
the outer shell having a plurality of gaps thereon for allowing one to see lip colors held in the transparent container part through it as well as the container part.

2. The lip container as claimed in claim 1, wherein there are plural separating plates formed in the transparent container part for dividing an inner space of the container part into plural holding rooms for containing different lip colors therein.

3. The lip container as claimed in claim 1, wherein an inner tube portion, which has an insertion hole, is provided in the transparent container part for containing a brush therein.
